(19) United States
(12) Patent Application Publication
(10) Pub. No.: US 2026/0195888 A1
(43) Pub. Date: Jul. 9, 2026

(54) METHOD AND APPARATUS WITH DEFECT DETECTION

(71) Applicant: SAMSUNG ELECTRONICS CO., LTD., Suwon-si (KR)

(72) Inventors: Minsu KANG, Suwon-si (KR); Kihyun KIM, Suwon-si (KR)

(73) Assignee: SAMSUNG ELECTRONICS CO., LTD., Suwon-si (KR)

(21) Appl. No.: 19/407,271

(22) Filed: Dec. 3, 2025

(30) Foreign Application Priority Data
Jan. 7, 2025 (KR) 10-2025-0002339

(51) Int. Cl. G06T 7/00; G06T 7/11

(52) U.S. Cl. CPC G06T 7/001; G06T 7/11; G06T 2207/10061; G06T 2207/30148

(57) ABSTRACT

A processor-implemented method including segmenting a target image to obtain a plurality of segmented images, searching for a first region having a first highest similarity between a first segmented image of the plurality of segmented images and a reference image, calculating a first index in a first overlap region to obtain a first value, searching for a second region having a second highest similarity between a second segmented image and the reference image in the reference image, calculating a second index in a second overlap region to obtain a second value, determining a position at which the target image and the reference image are aligned, and detecting a defect by applying a binarization threshold value to a difference in pixel values between the target image and the reference image in the final alignment position.

### CROSS-REFERENCE TO RELATED APPLICATION

This application claims priority to and the benefit of Korean Patent Application No. 10-2025-0002339 filed with the Korean Intellectual Property Office on Jan. 7, 2025, the entire contents of which are incorporated herein by reference.

### BACKGROUND

### (a) Field

The disclosure relates to a defect detection method and device.

### (b) Description of the Related Art

A high-resolution image may be used to analyze a microstructure in a semiconductor manufacturing process. Here, a high-resolution image may include an image generated by an optical microscope, electron microscope, or other high-resolution photographing equipment, including a scanning electron microscope (SEM) image. To analyze these types of high-resolution images (hereinafter, referred to as an image), it is typically necessary to align two images of the same size. To perform this alignment, a typical method may include each original image being Fourier transformed and then alignment information between the images is generated using cross-correlation. However, this typical method has a limitation in that the alignment accuracy can be significantly deteriorated when a noise level in the image is high or when there is a defect in the image. In particular, since the alignment accuracy of the method may drop to less than 80%, it may be difficult to apply the typical method to a semiconductor defect detection system which would normally require a precision of 99.9% or higher.

### SUMMARY

In a general aspect, here is provided a processor-implemented method including segmenting a target image to obtain a plurality of segmented images, searching for a first region having a first highest similarity between a first segmented image of the plurality of segmented images and a reference image while scanning a reference region having a same size as the first segmented image from among the plurality of segmented images in the reference image, calculating a first index in a first overlap region where the target image and the reference image overlaps based on the first region to obtain a first value, searching for a second region having a second highest similarity between a second segmented image of the plurality of segmented images and the reference image in the reference image while scanning a third region having a same size as the second segmented image from among the plurality of segmented images, calculating a second index in a second overlap region where the target image and the reference image overlap based on the second region to obtain a second value, determining a position at which the target image and the reference image are aligned as a final alignment position, such that a portion corresponding to the first segmented image in the target image corresponds to the first region in the reference image responsive to the first value being less than or equal to the second value, and

detecting a defect by applying a binarization threshold value to a difference in pixel values between the target image and the reference image in the final alignment position.

The method may include determining the binarization threshold value from the difference in pixel values between the target image and the reference image, the determining the binarization threshold value may include aligning a respective first image and a respective second image from among a plurality of pairs, each of the plurality of pairs including a first image and a second image, for each of the plurality of pairs in a phase correlation manner, calculating a distribution of a difference in pixel values between the respective first image and the respective second image for each of the plurality of pairs, and determining the binarization threshold value based on a value of a distribution selected from among distributions calculated for each of the plurality of pairs according to a predetermined reference.

The calculating of the distribution may include generating an array of difference values of gray levels for each pixel included in a fourth region within a predetermined distance to a vertex defined on the first image and the second image and calculating a standard deviation from the difference value array.

The determining the binarization threshold value based on the value of the selected distribution according to the predetermined reference may include sorting the standard deviation values in descending order and multiplying a value corresponding to a certain ratio among the sorted values by a predetermined multiple to determine the binarization value.

The method may include generating a plurality of subpixel-shifted segmented images by applying a subpixel shift for the first segmented image, searching for a first temporary region having a third highest similarity between a first subpixel-shifted segmented image and the reference image while scanning a fifth region having a same size as the first subpixel-shifted segmented image from among the plurality of subpixel-shifted segmented images in the reference image, calculating a third index in a first temporary overlap region where the target image and the reference image overlaps based on the first temporary region to obtain a first temporary value, searching for a second temporary region having a fourth highest similarity between a second subpixel-shifted segmented image and the reference image in the reference image while scanning a sixth region having a same size as the second subpixel-shifted segmented image from among the plurality of subpixel-shifted segmented images, calculating a second temporary index in a second overlap region where the target image and the reference image overlap based on the second temporary region to obtain a second temporary value, and treating the first temporary value as the first value and treating the first subpixel-shifted segmented image as the first segmented image responsive to the first temporary value being less than or equal to the second temporary value.

The generating the plurality of subpixel-shifted segmented images may include shifting the first segmented image by a first predetermined size of subpixels in at least one of a first axis direction and a second axis direction.

The generating the plurality of subpixel-shifted segmented images may include shifting the first segmented image by a second predetermined size of subpixels in a first axis direction and a second axis direction.

The generating the plurality of subpixel-shifted segmented images may include shifting the first segmented image by a subpixel unit of a third predetermined size in a first axis direction and a second axis direction such that a sum of a first shifting distance in the first axis direction and a second shifting distance in the second axis direction is constant.

The first index may include a ratio of a first area of the first overlap region and a second area of a threshold region in which a difference in pixel values between the target image and the reference image is greater than the binarization threshold value.

The method may include displaying the defect on a display device in an order of a calculated conversion area value among the detected defect according to an equation of converted area=area×(avg(|(|Δgraylevel)))ⁿ, where the converted area denotes a converted area value, area denotes an area of the defect after binarization, avg( ) is a first function to calculate an average, |(|) is a second function to calculate an absolute value, Δgraylevel is a difference in gray level between a target image and a reference image in each binarized region, and n denotes a real number. In a general aspect, here is provided a processor-implemented method

including segmenting a target image to obtain a plurality of segmented images, searching for a first region having a first highest similarity between a first segmented image of the plurality of segmented images and a reference image while scanning a reference region having a same size as the first segmented image from among the plurality of segmented images in the reference image, calculating a first index in a first overlap region where the target image and the reference image overlaps based on the first region to obtain a first value, searching for a second region having a second highest similarity between a second segmented image of the plurality of segmented images and the reference image in the reference image while scanning a third region having a same size as the second segmented image form among the plurality of segmented images, calculating a second index in a second overlap region where the target image and the reference image overlap based on the second region to obtain a second value, determining a position at which the target image and the reference image are aligned as a final alignment position, such that a portion corresponding to the first segmented image in the target image corresponds to the first region in the reference image responsive to the first value being less than or equal to the second value, and detecting a defect by applying a binarization threshold value to a difference in pixel values between the target image and the reference image in the final alignment position.

The method may include determining a plurality of subpixel-shifted segmented images by applying subpixel shift for the first segmented image, searching for a first temporary region having a third highest similarity between a first subpixel-shifted segmented image and the reference image while scanning a fourth region having a same size as the first subpixel-shifted segmented image from among the plurality of subpixel-shifted segmented images in the reference image, calculating a first temporary index in first temporary overlap region where the target image and the reference image overlaps based on the first temporary region to obtain a first temporary value, searching for a second temporary region having a fourth highest similarity between a second subpixel-shifted segmented image and the reference image in the reference image while scanning a fifth region having a same size as the second subpixel-shifted segmented image from among the plurality of subpixel-shifted segmented images, calculating a second temporary index in a second temporary region where the target image and the reference image overlap based on the second temporary region to obtain a second temporary value, and treating the first temporary value as the first value and treating the first subpixel-shifted segmented image as the first segmented image responsive to the first temporary value being less than or equal to the second temporary value.

The determining the plurality of subpixel-shifted segmented images may include shifting the first segmented image by a first predetermined size of subpixels in at least one of a first axis direction and a second axis direction.

The determining the plurality of subpixel-shifted segmented images may include shifting the first segmented image by a second predetermined size of subpixels in a first axis direction and a second axis direction.

The determining the plurality of subpixel-shifted segmented images may include shifting the first segmented image by a subpixel unit of a third predetermined size in a first axis direction and a second axis direction such that a sum of a first shifting distance in the first axis direction and a second shifting distance in the second axis direction is constant.

In a general aspect, here is provided an electronic apparatus including one or more processors including processing circuitry and a memory including one or more storage media storing instructions that, when executed individually or collectively by the one or more processors, cause the electronic apparatus to segment a target image to obtain a plurality of segmented images, search for a first region having a first highest similarity between a first segmented image of the plurality of segmented images and a reference image while scanning a reference region having a same size as the first segmented image from among the plurality of segmented images in the reference image, calculate a first index in a first overlap region where the target image and the reference image overlaps based on the first region to obtain a first value, search for a second region having a second highest similarity between a second segmented image of the plurality of segmented images and the reference image in the reference image while scanning a third region having same size as the second segmented image from among the plurality of segmented images, calculate a second index in a second overlap region where the target image and the reference image overlap based on the second region to obtain a second value, determine a position at which the target image and the reference image are aligned as a final alignment position, such that a portion corresponding to the first segmented image in the target image corresponds to the first region in the reference image responsive to the first value being less than or equal to the second value, and detect a defect by applying a binarization threshold value to a difference in pixel values between the target image and the reference image in the final alignment position.

The instructions may cause the electronic apparatus to determine a plurality of subpixel-shifted segmented images by applying a subpixel shift for the first segmented image, search for a first temporary region having a third highest similarity between a first subpixel-shifted segmented image and the reference image while scanning a fourth region having a same size as the first subpixel-shifted segmented image from among the plurality of subpixel-shifted segmented images in the reference image, calculate a first temporary index in a first temporary overlap region where the target image and the reference image overlaps based on the first temporary region to obtain a first temporary value, search for a second temporary region having a fourth highest similarity between a second subpixel-shifted segmented image and the reference image in the reference image while scanning a fifth region having a same size as the second subpixel-shifted segmented image from among the plurality of subpixel-shifted segmented images, calculate a second temporary index in a second temporary overlap region where the target image and the reference image overlap based on the second temporary region to obtain a second temporary value, and treat the first temporary value as the first value and treat the first subpixel-shifted segmented image as the first segmented image responsive to the first temporary value being less than or equal to the second temporary value.

The determining the plurality of subpixel-shifted segmented images may include shifting the first segmented image by a first predetermined size of subpixels in at least one of a first axis direction and a second axis direction.

The determining the plurality of subpixel-shifted segmented images may include shifting the first segmented image by a second predetermined size of subpixels in a first axis direction and a second axis direction.

The determining the plurality of subpixel-shifted segmented images may include shifting the first segmented image by a subpixel unit of a third predetermined size in a first axis direction and a second axis direction such that a sum of a first shifting distance in the first axis direction and a second shifting distance in the second axis direction is constant.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example electronic device with defect detection according to one or more embodiments.

FIGS. 2 and 3 illustrate example images according to one or more embodiments.

FIG. 4 illustrates an example process of image alignment according to one or more embodiments.

FIG. 5 illustrates an example method with a defect detection according to one or more embodiments.

FIG. 6 illustrates example images according to one or more embodiments.

FIG. 7 illustrates an example process with defect detection according to one or more embodiments.

FIG. 8 illustrates an example method with defect detection according to one or more embodiments.

FIG. 9 to FIG. 10 illustrates example images according to one or more embodiments.

FIG. 11 illustrates an example process with defect detection according to one or more embodiments.

FIG. 12 illustrates an example process with defect detection according to one or more embodiments.

FIG. 13 illustrates an example process with defect detection according to one or more embodiments.

FIG. 14 illustrates an example method with defect detection according to one or more embodiments.

FIG. 15 illustrates example images with defects according to one or more embodiments.

FIG. 16 illustrates an example electronic device according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment’ and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

One task to be solved is to solve an alignment accuracy deterioration problem that occurs in existing image alignment technology in the semiconductor field, and to provide a defect detection method and device that can achieve high alignment accuracy even in images containing noise and defects.

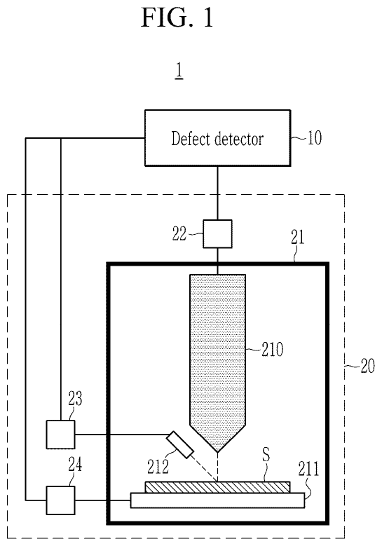

FIG. 1 illustrates an example electronic device with defect detection according to one or more embodiments.

Referring to FIG. 1, in a non-limiting example, an electronic device 1 with defect detection may include a defect detector 10 including a computing device (e.g., electronic device 50) and a scanning electron microscope (SEM) 20.

The SEM 20 may be a device that detects a secondary electron signal or backscattered electron signal generated by scanning a high energy electron beam on a sample surface, and analyzing a microstructure, a surface shape, a composition, and other physical characteristics of a sample through the generated signal. As illustrated in FIG. 1, in some examples, the SEM 20 may include a chamber 21 and controllers 22, 23, and 24. The chamber 21 provides an inspection space where a sample S is placed and an electron beam is scanned, and for example, it may be maintained in a vacuum state by a vacuum pump. Here, the sample S may include a silicon wafer, a semiconductor device divided into individual dies, and the like.

In an example, an electron gun 210, a test stage 211, and a detector 212 may be placed within the chamber 21. The electron gun 210 may generate an electron beam and scan the electron beam toward the sample S on the test stage 211 according to a control of the controller 22. The test stage 211 may support the sample S, and the controller 24 may move the test stage 211. A detector 212 may detect a signal emitted from the sample S, for example, a secondary electron or backscattered electron signal, and the controller 23 may receive the detected information and provide it to the defect detector 10. The defect detector 10 may obtain an SEM image by forming numerical data from an electric signal received from the detector 212, and to thereby detect defects in the SEM image.

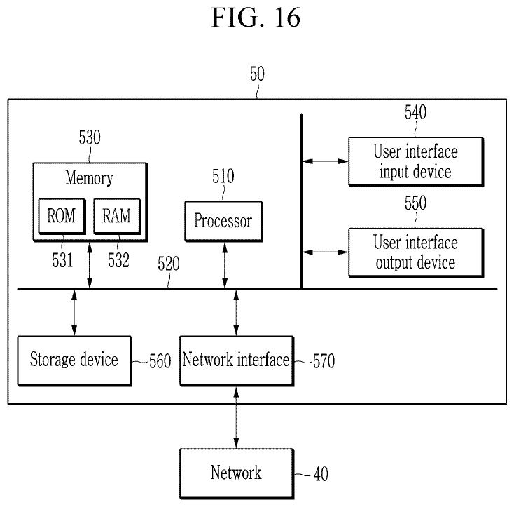

The defect detector 10 may execute a program code or instruction loaded into one or more memory devices through one or more processors. For example, the defect detector 10 may be implemented as an electronic device (e.g., electronic device 50 in FIG. 16). As described in greater detail below the electronic device may include one or more processors which may correspond to a processor 510 of the electronic device 50, and one or more memory devices which may correspond to a memory 520 of the electronic device 50. The program code or instruction may be executed by one or more processors to perform fault detection.

In an example, for the sake of clarity and convenience of description, the SEM 20 is described as being used in the defect detecting system 1. However, this configuration does not limit the scope of the present disclosure, and the SEM 20 may be replaced by an optical microscope, an electron microscope, or other high-resolution photographing equipment other than a SEM. That is, although the defect detector 10 and defect detection method described below are mainly described in relation to processing SEM images acquired through the SEM 20, the scope of the present disclosure may include cases of processing any other types of images other than SEM images.

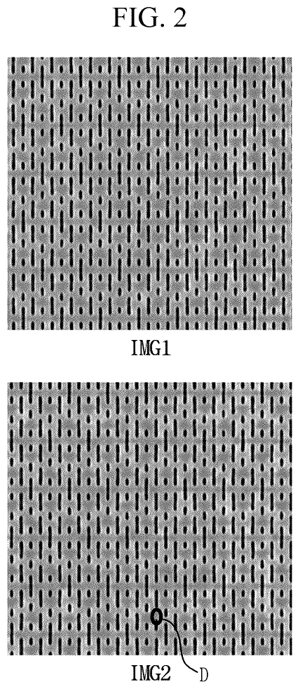

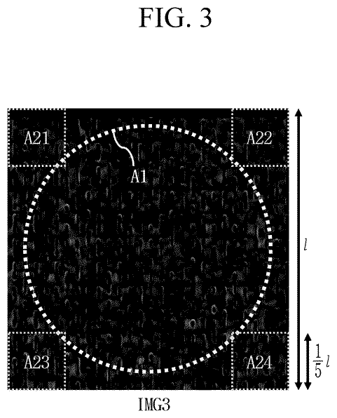

FIGS. 2 and 3 illustrate example images according to one or more embodiments.

Referring to FIG. 2, in a non-limiting example, the defect detector 10 may receive two types of SEM images, including a reference image IMG1 and a target image IMG2. The target image IMG2 is an image for which defects are to be detected, and may also be called a “defect suspected image”. The defect suspected image may be an SEM image measured at a position where there is a high possibility of a defect (indicated as “D” in FIG. 2) being present in the SEM measurement equipment. However, it cannot be guaranteed that there will always be a defect in that position. Although there is a case that a defect is found in around 90 % of the defect suspected image, there may also be cases where defects are found in less than 1 % of the defect suspected image. In a case where a ratio of an actual defect in a defect suspected image is very low, the remaining 99 % or more of the defect suspected image may be called “non-view”. In such a case, a worker may end up spending most of his time visually inspecting a defect-free SEM image, which may result in significant inefficiency. The reference image IMG1 is an image used as a comparison reference for detecting a defect in the target image, and may be an image obtained by measuring a cell right next to a cell that captured the target image IMG2 using the SEM measurement equipment. In general, there is a high probability that the reference image IMG1 will be free of a defect, but, in a rare case, it may contain a defect.

The defect detector 10 may receive the target image IMG2 and the reference image IMG1 as an input and calculate a difference between pixel values at the same coordinates of each image. The defect detector 10 may determine whether a specific pixel or region corresponds to a defect by applying a predetermined binarization threshold value to binarize the difference based on the pixel value difference calculated in this manner. When the pixel value difference exceeds the threshold value, the defect detector 10 considers that region as a defect, and when it does not exceed the threshold value, the defect detector 10 may process it as non-view. In addition, the binarized results may be saved or output for subsequent defect analysis or visual display.

However, it may be realistically difficult for a worker to manually find an appropriate threshold value every time. There may be a predetermined method for automatic thresholding, such as the Otsu binarization technique, which analyzes a brightness histogram of an image to maximize the dispersion between two groups. However, when a general automatic binarization technique such as the aforementioned method is applied to a difference between two SEM images, a threshold value tends to be set excessively low, which may deteriorate the defect detection accuracy.

To solve such problems, in an example, the defect detector 10 may set an automatic threshold value specialized for defect detection by determining (or calculating) a binarization threshold value from a pixel value difference between the target image IMG2 and the reference image IMG1. Specifically, the defect detector 10 may be provided with a plurality of paired images. For example, the defect detector 10 may be provided with, for example, 100 pairs of images. Each pair may include a first image and a second image. The first image may correspond to a defect suspected image, and the second image may correspond to a reference image for comparison. That is, the defect detector 10 may be provided with, for example, 100 pairs, where each pair is formed of a first image and a second image.

In an example, the defect detector 10 may align a first image and a second image for each of the plurality of pairs in a phase correlation manner. The phase correlation manner is a technique for performing alignment by calculating a relative displacement between two images in a frequency domain. After performing a Fourier transform on the two images, the phase information of the transformed result may be used to calculate a translation between the images. Specifically, a phase correlation matrix is calculated for the Fourier transform results of the two images, and the coordinate with the highest value in the spectrum obtained through the inverse Fourier transform of the matrix may be determined as a translation vector between the images. The phase correlation method may be directly applied to align two SEM images of the same size, and has the merit of providing relatively fast execution speed. However, the application of the Fourier Shift Theorem based on the Fourier transform may be inappropriate for images containing periodic patterns or images with large defect sizes. In such cases, the worst case scenario may result in alignment accuracy dropping to around 80% or less. However, examples of the defect detector 10 may use the phase correlation manner for quick alignment in the process of calculating the binarization threshold value, and may use a different method, which will be described in greater detail below, rather than the phase correlation manner in the subsequent defect detection process.

The defect detector 10 may calculate the distribution of the pixel value difference between the first image and the second image for each of the plurality of pairs. In some examples, the distribution calculated by the defect detector 10 may be a standard deviation of the SEM noise. The defect detector 10 may calculate a binarization threshold value based on a value of a distribution selected according to a predetermined reference among distributions calculated for each of the plurality of pairs. For example, the defect detector 10 may determine the binarization threshold value as a value corresponding to 5 times the standard deviation of the SEM noise.

Referring to FIG. 3, in a non-limiting example, an image IMG3 may be a result image from an operation for a difference between the first image and the second image. The defect detector 10 may analyze only a part of the SEM image for measuring the SEM noise. Specifically, the distribution of the difference in pixel values between the first image and the second image may generate an array of difference values of gray levels for each pixel included in regions A21, A22, A23, and A24 that are near the vertices defined on the first image and the second image, and may include a standard deviation calculated from the difference value array. That is, defect detector 10 may measure the SEM noise only for the near-vertex regions A21, A22, A23, and A24. This is because, in terms of the characteristics of the SEM image, defects are mainly detected in the region indicated by A1, and the frequency of occurrence of defects near the vertex of the image is relatively low.

In some examples, when a length of one side of the result image IMG3, which, as described above, is obtained by operating the difference between the first image and the second image, is l, a length of one side of each of the regions A21, A22, A23, and A24 near the vertex may be set to

$$\frac{1}{5} l .$$

Meanwhile, in some examples, the defect detector 10 may calculate a binarization threshold value by sorting standard deviation values in descending order and multiplying a value corresponding to a high certain ratio among the values sorted in the descending order by a determined multiple to calculate a binarization threshold value based on values of selected distribution according to a predetermined reference.

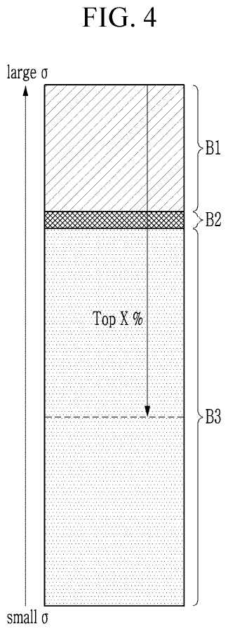

FIG. 4 illustrates an example process of image alignment according to one or more embodiments.

Referring to FIG. 4, in a non-limiting example, the defect detector 10 may a perform alignment of a first image and a second image in the phase correlation manner for, for example, 100 pairs of images. As described above, the phase correlation manner may lead to successful alignment of 80 out of 100 pairs and failure in alignment of 20 pairs, assuming an accuracy of about 80%. For the 20 pairs that failed to align, the standard deviation values include relatively large values, which may be included in the region indicated as B1. Meanwhile, among the 80 pairs that were successfully aligned, a standard deviation value of one pair that had a defect in a region near the vertex is smaller than that of the cases where the alignment failed, but still includes a large value, and may be included in a region indicated as B2. In addition, among the 80 pairs that are successfully aligned, 79 pairs that do not have defects in a region near the vertex have relatively small standard deviation values and may be included in the region indicated as B3. The standard deviation values calculated for each of the 100 pairs may be sorted in descending order, and the top X% of the sorted values (where X is a real number between 0 and 100), for example the top 60%, may be multiplied by a fixed multiple, for example 5, to calculate the binarization threshold value.

The binarization threshold values obtained in the manner described in FIG. 2 to FIG. 4 may be automatically set based on statistical analysis of SEM noise. Through this, SEM noise and defects can be efficiently distinguished, and the accuracy of defect detection can be improved by setting an appropriate threshold value.

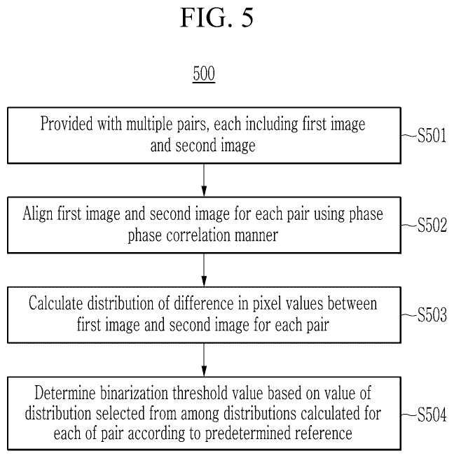

FIG. 5 illustrates an example method with a defect detection according to one or more embodiments.

Referring to FIG. 5, in a non-limiting example, an electronic apparatus (e.g., electronic apparatus 50 of FIG. 16) may perform defect detection through a method 500 with defect detection which may include being provided with a plurality of pairs, each including a first image and a second image in step S501, aligning the first image and the second image for each of the plurality of pairs using a phase correlation manner in step S502, calculating distribution of a difference in pixel values between the first image and the second image for each of the plurality of pairs in step S503, and determining a binarization threshold value based on a value of distribution selected from among the distributions calculated for each of the plurality of pairs according to a predetermined reference in step S504.

For more detailed information about the method 500, refer to the description of examples described in this specification, and therefore redundant description is omitted here.

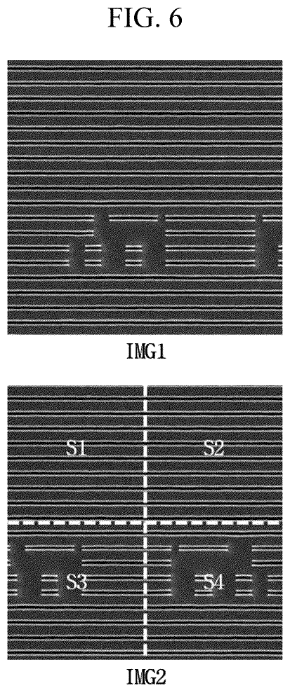

FIG. 6 illustrates example images according to one or more embodiments.

Referring to FIG. 6, in a non-limiting example, the defect detector 10 may obtain a plurality of segmented images S1, S2, S3, and S4 by segmenting the target image IMG2 and search for and match regions corresponding to the plurality of segmented images S1, S2, S3, and S4 in the reference image IMG1 to thereby align target image IMG2 and the reference image IMG1.

Specifically, the defect detector 10 may search for a first region having a highest similarity between a first segmented image and the reference image IMG1 by scanning regions having the same size as the first segmented image among the plurality of segmented images S1, S2, S3, and S4 in the reference image IMG1. The defect detector 10 may obtain a first value by calculating (or determining) a first index in a region where the target image IMG2 and the reference image IMG1 overlap based on the first region. Specifically, the defect detector 10 may align the target image IMG2 and the reference image IMG1 and obtain a first value by calculating a second index in a region where target image IMG2 and reference image IMG1 overlap such that a portion in the target image IMG2, corresponding to the first segmented image corresponds to the first region in the reference image IMG1.

In some examples, the index may include z ratio of the area of a region where a difference in pixel values between the target image IMG2 and the reference image IMG1 is greater than a binarization threshold value, compared to the area of the region where the target image IMG2 and the reference image IMG1 overlap.

Meanwhile, the defect detector 10 may search for a second region having a highest similarity between a second segmented image and the reference image IMG1 by scanning a region having the same size as the second segmented image among the plurality of segmented images S1, S2, S3, and S4 in the reference image IMG1. The defect detector 10 may align the target image IMG2 and the reference image IMG1 based on the second region, and obtain a second value by calculating an index in the region where the target image IMG2 and the reference image IMG1 overlap. Specifically, the defect detector 10 may align the target image IMG2 and the reference image IMG1 and obtain the second value by calculating an index in the region where the target image IMG2 and the reference image IMG1 overlap such that a part corresponding to the second segmented image of the target image IMG2 can correspond to the second region in the reference image IMG1,

When the first value is less than or equal to the second value, the defect detector 10 may determine a position at which the target image IMG2 and the reference image IMG1 are aligned as a final alignment position such that a part corresponding to the first segmented image of the target image IMG2 can correspond to the first region on the reference image IMG1.

The defect detector 10 may detect a defect by applying a binarization threshold value to the difference in pixel values between the target image IMG2 and the reference image IMG1 at the final alignment position determined in such a manner.

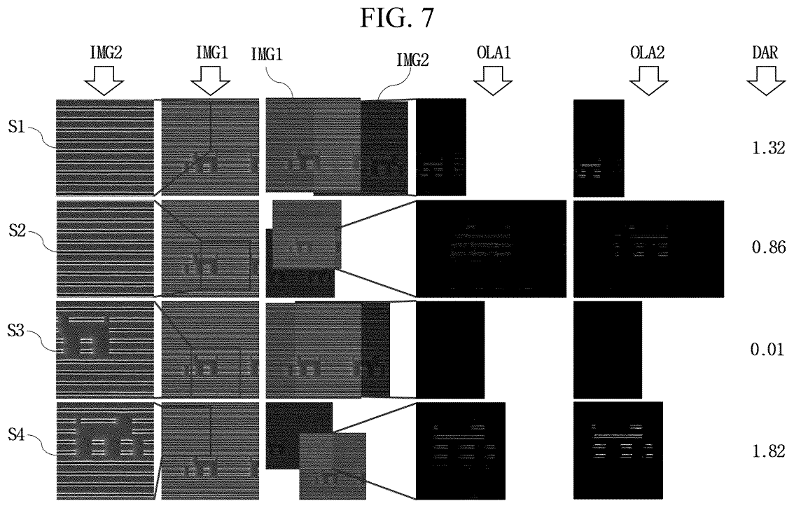

FIG. 7 illustrates an example process with defect detection according to one or more embodiments.

Referring to FIG. 7, in a non-limiting example, the defect detector 10 may search for a region with a highest similarity between the segmented image S1 and the reference image IMG1 by scanning a region having the same size as the segmented image S1 among the plurality of segmented images S1, S2, S3, and S4 in the reference image IMG1. For example, the defect detector 10 may align the target image IMG2 and the reference image IMG1 and obtain a value of 1.32 by calculating a predetermined index DAR in regions OLA1 and OLA2 where the target image IMG2 and the reference image IMG1 overlap such that a part of the target image IMG2, corresponding to the segmented image S1 can correspond to the searched region in the reference image IMG1. Here, the overlapped region OLA2 may represent a result of binarization performed using a threshold value as a reference in the overlapped region OLA1, which represents the difference between images IMG1 and IMG2.

In addition, the defect detector 10 may search for a region with a highest similarity between a segmented image S2 and the reference image IMG1 by scanning a region having the same size as the segmented image S2 among the plurality of segmented images S1, S2, S3, and S4 in the reference image IMG1. For example, the defect detector 10 may align the target image IMG2 and the reference image IMG1 and obtain a value of 0.86 by calculating the predetermined index DAR in the regions OLA1 and OLA2 where the target image IMG2 and the reference image IMG1 overlap such that a part of the target image IMG2, corresponding to the segmented image S2 can correspond to the searched region in the reference image IMG1.

In addition, the defect detector 10 may search for a region with a highest similarity between a segmented image S3 and the reference image IMG1 by scanning a region having the same size as the segmented image S3 among the plurality of segmented images S1, S2, S3, and S4 in the reference image IMG1. For example, the defect detector 10 may align the target image IMG2 and the reference image IMG1 and obtain a value of 0.01 by calculating the predetermined index DAR in the regions OLA1 and OLA2 where the target image IMG2 and the reference image IMG1 overlap such that a part of the target image IMG2 corresponding to the segmented image S3 can correspond to the searched region in the reference image IMG1.

In addition, the defect detector 10 may search for a region with a highest similarity between a segmented image S4 and the reference image IMG1 by scanning a region having the same size as the segmented image S4 among the plurality of segmented images S1, S2, S3, and S4 in the reference image IMG1. For example, the defect detector 10 may align the target image IMG2 and the reference image IMG1 and obtain a value of 1.82 by calculating the predetermined index DAR in the regions OLA1 and OLA2 where the target image IMG2 and the reference image IMG1 overlap such that a part of the target image IMG2, corresponding to the segmented image S4 can correspond to the searched region in the reference image IMG1.

Since, in the above examples, the index DAR is the lowest for the segmented image S3, the defect detector 10 may determine the position at which the target image IMG2 and the reference image IMG1 are aligned as the final alignment position such that the part corresponding to the segmented image S3 among the target image IMG2 can correspond to the searched region in the reference image IMG1, and may detect a defect by applying a binarization threshold value to the pixel value difference between the target image IMG2 and the reference image IMG1 at the final alignment position determined in such a manner. In this way, the alignment accuracy of the target image IMG2 and the reference image IMG1 may be improved.

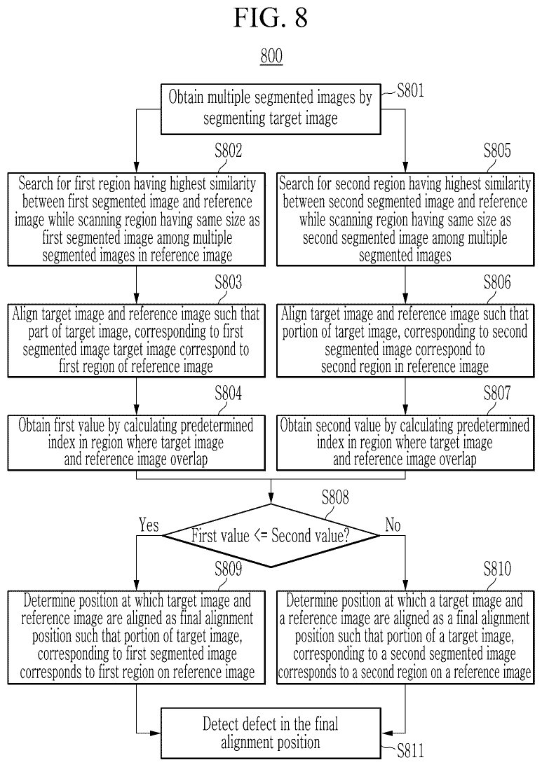

FIG. 8 illustrates an example method with defect detection according to one or more embodiments.

Referring to FIG. 8, in a non-limiting example, an electronic apparatus (e.g., electronic apparatus 50 of FIG. 16) may perform defect detection through a method 800 with defect detection which may include obtaining a plurality of segmented images by segmenting a target image in step S801.

In an example, an electronic apparatus (e.g., electronic apparatus 50 of FIG. 16) may perform defect detection through method 800 with defect detection which may include searching for a first region having the highest similarity between a first segmented image and a reference image while scanning a region having the same size as the first segmented image among the plurality of segmented images in the reference image in step S802, aligning a target image and the reference image such that a part of a target image, corresponding to the first segmented image target image can correspond to a first region of the reference image in step S803, and obtaining a first value by calculating a predetermined index in a region where the target image and the reference image overlap in step S804.

In an example, the method 800 with defect detection may also include searching for a second region having the highest similarity between a second segmented image and the reference while scanning a region having the same size as the second segmented image among the plurality of segmented images in step S805, aligning the target image and the reference image such that a portion of the target image, corresponding to the second segmented image can correspond to the second region in the reference image in step S806, and obtaining a second value by calculating a predetermined index in a region where the target image and the reference image overlap in step S807.

The method 800 may also perform determining, in step S808, whether the first value obtained in step S804 is less than or equal to the second value obtained in step S807.

When the first value is determined to be less than or equal to the second value (“Yes” in step S808), the defect detection method may perform determining in step S809 a position at which the target image and the reference image are aligned as the final alignment position such that a portion of the target image, corresponding to the first segmented image corresponds to the first region on the reference image.

On the other hand, when the first value is determined to exceed the second value (“No” in step S808), the defect detection method may perform, in step S810, determining of a position at which the target image and the reference image are aligned as the final alignment position such that a portion of the target image, corresponding to the second segmented image corresponds to the second region on the reference image.

The method 800 may perform, in step S811, detecting of a defect in the final alignment position that was determined in steps S809 or S810.

For more detailed information about the defect detection method, refer to the description of examples described in this specification, and thus a redundant description will be is omitted.

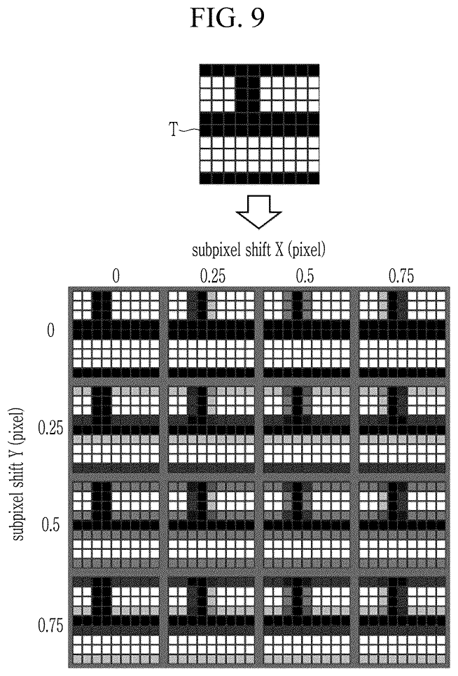

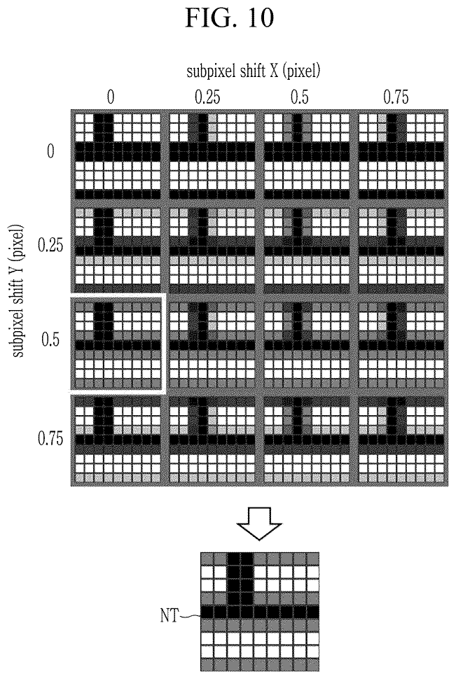

FIG. 9 to FIG. 10 illustrates example images according to one or more embodiments.

Referring to FIG. 9, in a non-limiting example, the defect detector 10 may generate a plurality of subpixel-shifted segmented images by applying subpixel shift to each of the segmented images S1, S2, S3, and S4 of FIG. 6 and FIG. 7, and further improve the alignment accuracy between target image IMG2 and reference image IMG1 using the plurality of subpixel-shifted segmented images, in addition to the alignment method described above with reference to FIG. 6 and FIG. 7.

The plurality of subpixel-shifted segmented images may be generated by shifting segmented images by a predetermined size of subpixels in at least one of a first axis (e.g., horizontal axis) direction and a second axis (e.g., vertical axis) direction. For example, the defect detector 10 may generate 16 subpixel-shifted segmented images by applying the subpixel shift to any random segmented image T among the plurality of segmented images S1, S2, S3, and S4 of FIG. 6 and FIG. 7. For example, the 16 subpixel-shifted segmented images may be generated according to all combinations of shifting in the horizontal direction by 0 pixel, 0.25 pixel, 0.5 pixel or 0.75 pixel, and shifting in the vertical direction by 0 pixel, 0.25 pixel, 0.5 pixel or 0.75 pixel, as illustrated.

In an example, the defect detector 10 may search for a first temporary region having the highest similarity between the first subpixel-shifted segmented image and the reference image IMG1 by scanning a region having the same size as the first subpixel-shifted segmented image among the plurality of subpixel-shifted segmented images in the reference image IMG1. The defect detector 10 may obtain a first temporary value by calculating a first index (i.e., a first temporary index) in a region where the target image IMG2 and the reference image IMG1 overlap based on the first temporary region. Specifically, the defect detector 10 may align the target image IMG2 and the reference image IMG1 and obtain the first temporary value by calculating index (i.e., the first temporary index) in the region where the target image IMG2 and the reference image IMG1 overlap such that a portion of the target image IMG2, corresponding to the first subpixel-shifted segmented image can correspond to the first temporary region in the reference image IMG1.

Meanwhile, in an example, the defect detector 10 may search for a second temporary region having the highest similarity between a second subpixel-shifted segmented image and the reference image IMG1 by scanning a region having the same size as the second subpixel-shifted segmented image among the plurality of subpixel-shifted segmented images in the reference image IMG1. The defect detector 10 may obtain a second temporary value by calculating a second index (i.e., a second temporary index) in the region where the target image IMG2 and the reference image IMG1 overlap based on the second temporary region. Specifically, the defect detector 10 may align the target image IMG2 and the reference image IMG1 and obtain the second temporary value by calculating an index (i.e., the second temporary index) in the region where the target image IMG2 and the reference image IMG1 overlap such that a portion of the target image IMG2, corresponding to the second subpixel-shifted segmented image can correspond to the second temporary region in the reference image IMG1.

When the first temporary value is less than or equal to the second temporary value, the defect detector 10 may treat the first temporary value as the first value and treat the first subpixel-shifted segmented image as the first segmented image.

Referring to FIG. 10, in a non-limiting example, when a subpixel-shifted segmented image corresponding to the smallest temporary value is a subpixel-shifted segmented image NT obtained by shifting the segmented image T by 0 pixel in the horizontal direction and by 0.5 pixel in the vertical direction, the defect detector 10 may determine a position at which the target image and the reference image are aligned as a final alignment position such that a part of the target image, corresponding to the determined subpixel-shifted segmented image NT can correspond to a searched region in the reference image.

When the alignment method described in relation to FIG. 6 to FIG. 7 operates based on matching of pixel units, the alignment method described in relation to FIG. 9 to FIG. 10 operates based on matching of subpixel units, which can further improve the alignment accuracy of the target image IMG2 and the reference image IMG1.

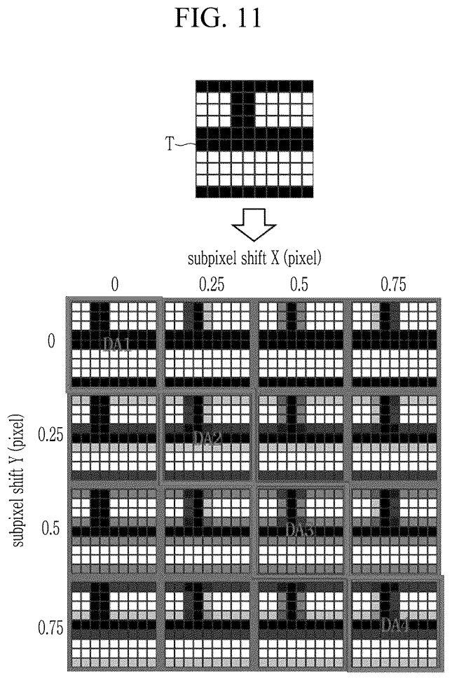

FIG. 11 illustrates an example process with defect detection according to one or more embodiments.

Referring to FIG. 11, in a non-limiting example, in order to reduce the computational complexity of the alignment method described with reference to FIG. 9 to FIG. 10, instead of generating the plurality of subpixel-shifted segmented images with subpixel shift applied to each of the segmented images S1, S2, S3, and S4 of FIG. 6 and FIG. 7, only some of them may be generated. That is, the plurality of subpixel-shifted segmented images may be generated by shifting the segmented image in the first axis (e.g., horizontal axis) direction and the second axis (e.g., vertical axis) direction by a predetermined size of subpixels. For example, the defect detector 10 may generate four subpixel-shifted segmented images by applying the subpixel shift to any segmented image T among the plurality of segmented images S1, S2, S3, and S4. For example, the four subpixel-shifted segmented images may include a subpixel-shifted segmented image DA1 that is shifted 0 pixel in a horizontal direction and 0 pixel in a vertical direction, a subpixel-shifted segmented image DA2 that is shifted 0.25 pixel in a horizontal direction and 0.25 pixel in a vertical direction, a subpixel-shifted segmented image DA3 that is shifted 0.5 pixel in a horizontal direction and 0.5 pixel in a vertical direction, and a subpixel-shifted segmented image DA4 that is shifted 0.75 pixel in a horizontal direction and 0.75 pixel in a vertical direction, as illustrated.

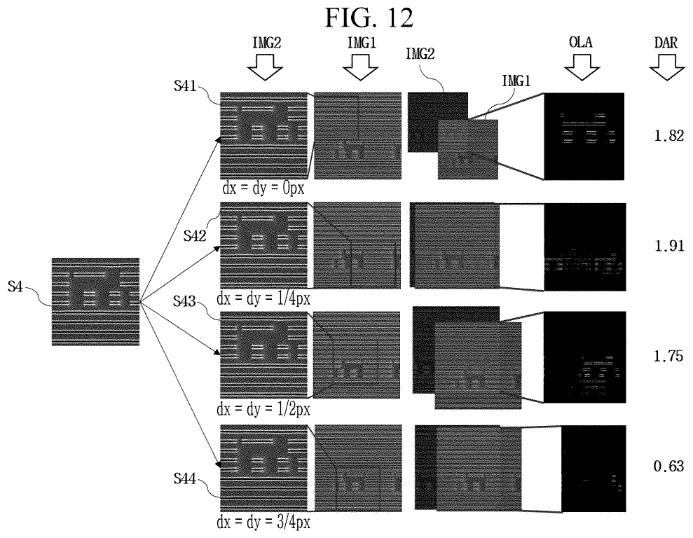

FIG. 12 illustrates an example process with defect detection according to one or more embodiments.

Referring to FIG. 12, in a non-limiting example, the defect detector 10 may generate a plurality of subpixel-shifted segmented images S41, S42, S43, and S44 by applying subpixel shift to the segmented image S4.

The defect detector 10 may search for a temporary region with the highest similarity between the subpixel-shifted segmented image S41 and the reference image IMG1 by scanning a region having the same size as the subpixel-shifted segmented image S41 among the plurality of subpixel-shifted segmented images S41, S42, S43, and S44 in the reference image IMG1

For example, the defect detector 10 may align the target image IMG2 and the reference image IMG1 and obtain a value of 1.82 by calculating an index DAR in a region OLA where the target image IMG2 and the reference image IMG1 overlap such that a part of the target image IMG2, corresponding to the subpixel-shifted segmented image S41 can correspond to the searched temporary in the reference image IMG1.

In addition, the defect detector 10 may search for a temporary region with a highest similarity between the subpixel-shifted segmented image S42 and the reference image IMG1 by scanning a region having the same size as the subpixel-shifted segmented image S42 among the plurality of subpixel-shifted segmented images S41, S42, S43, and S44 in the reference image IMG1. For example, the defect detector 10 may align the target image IMG2 and the reference image IMG1 and obtain a value of 1.91 by calculating an index DAR in the region OLA where the target image IMG2 and the reference image IMG1 overlap such that a part of the target image IMG2, corresponding to the subpixel-shifted segmented image S42 can correspond to the searched temporary region in the reference image IMG1.

In addition, the defect detector 10 may search for a temporary region with a highest similarity between the subpixel-shifted segmented image S43 and the reference image IMG1 by scanning a region having the same size as the subpixel-shifted segmented image S43 among the plurality of subpixel-shifted segmented images S41, S42, S43, and S44 in the reference image IMG1. For example, the defect detector 10 may align the target image IMG2 and the reference image IMG1 and obtain a value of 1.75 by calculating an index DAR in the region OLA where the target image IMG2 and the reference image IMG1 overlap such that a part of the target image IMG2, corresponding to the subpixel-shifted segmented image S43 can correspond to the searched temporary region in the reference image IMG1.

In addition, the defect detector 10 may search for a temporary region with a highest similarity between the subpixel-shifted segmented image S44 and the reference image IMG1 by scanning a region having the same size as the among the plurality of subpixel-shifted segmented images S41, S42, S43, and S44 in the reference image IMG1. For example, the defect detector 10 may align the target image IMG2 and the reference image IMG1 and obtain a value of 0.63 by calculating an index DAR in the region OLA where the target image IMG2 and the reference image IMG1 overlap such that a part of the target image IMG2, corresponding to the segmented image S4 can correspond to the searched temporary region in the reference image IMG1.

Since the index DAR of the subpixel-shifted segmented image S44 is the lowest, the defect detector 10 may treat the value 0.63 as the index DAR of the segmented image S4 and treat the subpixel-shifted segmented image S44 as the segmented image S4. Thereafter, a comparison of the indexes DAR for the plurality of segmented images S1, S2, S3, and S4 can be performed, as in the alignment method described with respect to FIG. 6 to FIG. 7.

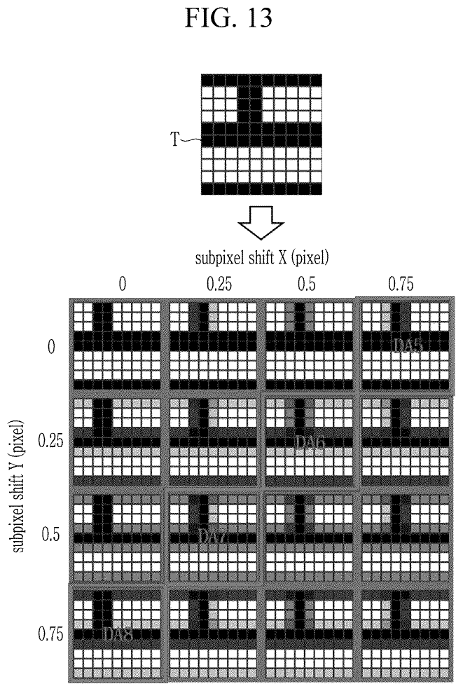

FIG. 13 illustrates an example process with defect detection according to one or more embodiments.

Referring to FIG. 13, in a non-limiting example, in order to reduce the computational complexity of the alignment method described with reference to FIG. 9 to FIG. 10, instead of generating the plurality of subpixel-shifted segmented images with subpixel shift applied to each of the segmented images S1, S2, S3, and S4, only some of them may be generated. That is, the plurality of subpixel-shifted segmented images may be generated by shifting the segmented image in the first axis (e.g., horizontal axis) direction and the second axis (e.g., vertical axis) direction by a predetermined size of subpixels, while maintaining the sum of a shifting distance in the first axis direction and a shifting distance in the second axis direction to be constant. For example, the defect detector 10 may generate four subpixel-shifted segmented images by applying the subpixel shift to any segmented image T among the plurality of segmented images S1, S2, S3, and S4. For example, the four subpixel-shifted segmented images may include a subpixel-shifted segmented image DA5 that is shifted 0.75 pixel in a horizontal direction and 0 pixel in a vertical direction, a subpixel-shifted segmented image DA6 that is shifted 0.5 pixel in a horizontal direction and 0.25 pixel in a vertical direction, a subpixel-shifted segmented image DA7 that is shifted 0.25 pixel in a horizontal direction and 0.5 pixel in a vertical direction, and a subpixel-shifted segmented image DA8 that is shifted 0 pixel in a horizontal direction and 0.75 pixel in a vertical direction, as illustrated.

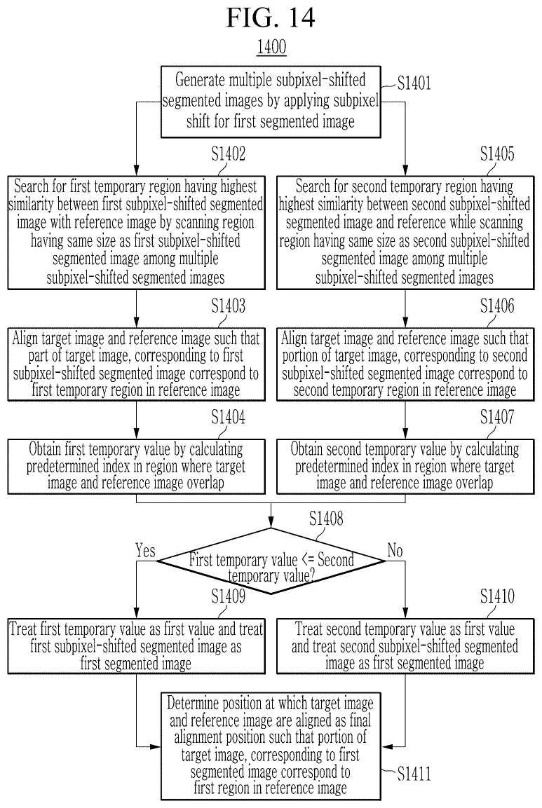

FIG. 14 illustrates an example method with defect detection according to one or more embodiments.

Referring to FIG. 14, in a non-limiting example, an electronic apparatus (e.g., electronic apparatus 50 of FIG. 16) may perform defect detection through a method 1400 with defect detection which may include generating a plurality of subpixel-shifted segmented images by applying subpixel shift for a first segmented image in step S1401.

The method 1400 may further include, in a reference image, searching for a first temporary region having a highest similarity between a first subpixel-shifted segmented image with the reference image by scanning a region having the same size as the first subpixel-shifted segmented image among the plurality of subpixel-shifted segmented images in step S1402, aligning a target image and the reference image such that a part of the target image, corresponding to the first subpixel-shifted segmented image can correspond to the first temporary region in the reference image in step S1403, and obtaining a first temporary value by calculating a predetermined index in a region where the target image and the reference image overlap in step S1404.

Meanwhile, in an example, the defect detection method may include searching for a second temporary region having a highest similarity between a second subpixel-shifted segmented image and the reference while scanning a region having the same size as the second subpixel-shifted segmented image among the plurality of subpixel-shifted segmented images in step S1405, aligning the target image and the reference image such that a portion of the target image, corresponding to the second subpixel-shifted segmented image can correspond to the second temporary region in the reference image in step S1406, and obtaining a second temporary value by calculating a predetermined index in the region where the target image and the reference image overlap in step S1407.

In an example, the defect detection method may perform determining in step S1408 whether the first temporary value obtained in step S1404 is less than or equal to the second temporary value obtained in step S1407.

When the first temporary value is determined to be less than or equal to the second temporary value (“Yes” in S1408), the defect detection method may perform treating the first temporary value as a first value and treating the first subpixel-shifted segmented image as a first segmented image in step S1409.

Alternatively, when the first temporary value is determined to exceed the second temporary value (“No” in step S1408,), the defect detection method may perform treating the second temporary value as the first value and treating the second subpixel-shifted segmented image as the first segmented image in step S1410.

The defect detection method may additionally perform determining a position at which the target image and the reference image are aligned as a final alignment position such that a portion of the target image, corresponding to the first segmented image can correspond to a first region in the reference image in step S1411.

For more detailed information about the defect detection method, refer to the description of the examples described in this specification, and therefore redundant description will be omitted.

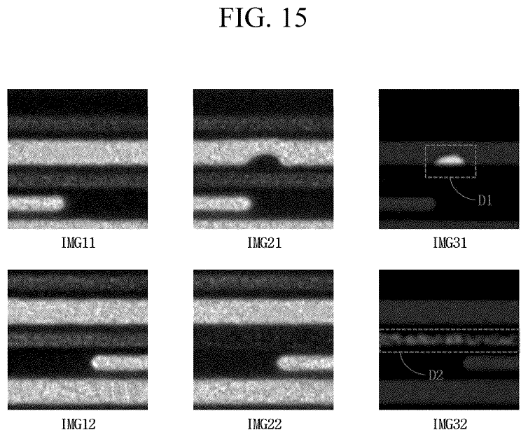

FIG. 15 illustrates example images with defects according to one or more embodiments e.

Referring to FIG. 15, in a non-limiting example, an image IMG31 in which a defect D1 is detected with respect to a reference image IMG11 and a target image IMG21, and an image IMG32 in which a defect D2 is detected with respect to a reference image IMG12 and a target image IMG22 are illustrated. In an example, the defect detector 10 may display defects on a display device in descending order of a converted area value calculated according to equation 1 as illustrated below among the detected defects.

$$converted area = area \times {( avg ( \vert ( \vert Δ graylevel ) ) )}^{n} \qquad Equation l$$

In equation 1, converted area denotes a converted area value, area denotes the area of the defect after binarization, avg( ) is a function that calculates the average, |(|) is a function that calculates the absolute value, Δgraylevel is a difference in gray level between a target image and a reference image in each binarized region, and n can be a real number. That is, the defect detector 10 does not simply display the defect D2 with a larger area before the defect D1 with a smaller area, but may numerically assign importance to defects using the above method, and thus the defect D1 with a higher importance may be displayed before the defect D2 with lower importance. Accordingly, the time required to confirm inspection results can be shortened.

FIG. 16 illustrates an example electronic device according to one or more embodiments.

Referring to FIG. 16, in a non-limiting example, the defect detection method and apparatus according to the examples may be implemented using a electronic device 50. The electronic device 50 may be implemented as various types of electronic devices, servers or similar devices, and their functions may be implemented through a combination of software and hardware.

The electronic device 50 may include at least one of a processor 510, a memory 530, a user interface input device 540, a user interface output device 550, and a storage device 560 communicating via a bus 520. The electronic device 50 may also include a network interface 570 electrically connected to a network 40. The network interface 570 may transmit or receive signals to other entities via the network 40.

The processor 510 may be configured to execute programs or applications to configure the processor 510 to control the electronic device 50 to perform one or more or all operations and/or methods involving providing of positional encoding to a neural network. The processor 510 may be implemented with various types of operating (e.g., computing) units, such as a micro controller unit (MCU), an application processor (AP), a central processing unit (CPU), a graphic processing unit (GPU), a neural processing unit (NPU), and a quantum processing unit (QPU). The processor 510 is a semiconductor device that executes instructions stored in the memory 530 or the storage device 560 and may perform a key role in the system. A program code and data stored in the memory 530 or the storage device 560 instruct the processor 510 to perform a specific task, thereby enabling system-wide operation. The processor 510 may be configured to implement various functions and methods described above with reference to FIG. 1 to FIG. 15.

The memory 530 may include computer-readable instructions. The processor 510 may be configured to execute computer-readable instructions, such as those stored in the memory 530, and through execution of the computer-readable instructions, the processor 510 may be configured to perform one or more, or any combination, of the operations and/or methods described herein. The memory 530 and the storage device 560 may include various types of volatile or non-volatile storage media for storing and accessing data of the system. For example, the memory 530 may include a read-only memory (ROM) 531 and a random access memory (RAM) 532. In some examples, the memory 530 may be embedded within the processor 510, in which case data transmission speed between the memory 530 and the processor 510 may be very fast. In some examples, the memory 530 may be disposed external to the processor 510, in which case the memory 530 may be connected to the processor 510 via various data buses or interfaces. Such a connection may be made via a variety of known means, for example a peripheral component interconnect express (PCIe) interface for high-rate data transmission or via a memory controller.

In an example, at least some components or functions of the defect detection method and device according to the examples may be implemented as a program or software running on the electronic device 50, and the program or software can be stored on a computer-readable recording medium or storage medium. Specifically, in an example, a computer-readable recording medium or storage medium according to an example may record a program for causing a computer including the processor 510 to execute a program or instruction stored in the memory 530 or the storage device 560, to execute steps included in the implementation of the defect detection method and device according to the examples.

In some examples, at least some components or functions of the defect detection method and device according to the examples may be implemented using hardware or circuitry of the electronic device 50, or may be implemented as separate hardware or a circuit that may be electrically connected to the electronic device 50.

In an example, the alignment accuracy deterioration problem that occurs in existing image alignment techniques in the semiconductor field can be solved, and high alignment accuracy even in images containing noise and defects can be achieved.

The electronic devices, processors, memories, neural networks, electronic device 1, defect detector 10, SEM 20, controllers 22, 23, and 24, electronic device 50, processor 510, a memory 530, user interface input device 540, user interface output device 550, storage device 560, and network interface 570 described herein, including descriptions with respect to respect to FIGS. 1-16, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-16 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, comprising:
segmenting a target image to obtain a plurality of segmented images;
searching for a first region having a first highest similarity between a first segmented image of the plurality of segmented images and a reference image while scanning a reference region having a same size as the first segmented image from among the plurality of segmented images in the reference image;
calculating a first index in a first overlap region where the target image and the reference image overlaps based on the first region to obtain a first value;
searching for a second region having a second highest similarity between a second segmented image of the plurality of segmented images and the reference image in the reference image while scanning a third region having a same size as the second segmented image from among the plurality of segmented images;
calculating a second index in a second overlap region where the target image and the reference image overlap based on the second region to obtain a second value;
determining a position at which the target image and the reference image are aligned as a final alignment position, such that a portion corresponding to the first segmented image in the target image corresponds to the first region in the reference image responsive to the first value being less than or equal to the second value; and
detecting a defect by applying a binarization threshold value to a difference in pixel values between the target image and the reference image in the final alignment position.

2. The method of claim 1, further comprising:
determining the binarization threshold value from the difference in pixel values between the target image and the reference image,
wherein the determining the binarization threshold value comprises:
aligning a respective first image and a respective second image from among a plurality of pairs, each of the plurality of pairs including a first image and a second image, for each of the plurality of pairs in a phase correlation manner;
calculating a distribution of a difference in pixel values between the respective first image and the respective second image for each of the plurality of pairs; and
determining the binarization threshold value based on a value of a distribution selected from among distributions calculated for each of the plurality of pairs according to a predetermined reference.

3. The method of claim 2, wherein calculating the distribution of the pixel value difference between the first respective image and the respective second image for each of the plurality of pairs comprises:
generating an array of difference values of gray levels for each pixel included in a fourth region within a predetermined distance to a vertex defined on the first image and the second image; and
calculating a standard deviation from the difference value array.

4. The method of claim 3, wherein the determining the binarization threshold value based on the value of the selected distribution according to the predetermined reference comprises:
sorting the standard deviation values in descending order; and
multiplying a value corresponding to a certain ratio among the sorted values by a predetermined multiple to determine the binarization value.

5. The method of claim 1, further comprising:
generating a plurality of subpixel-shifted segmented images by applying a subpixel shift for the first segmented image;
searching for a first temporary region having a third highest similarity between a first subpixel-shifted segmented image and the reference image while scanning a fifth region having a same size as the first subpixel-shifted segmented image from among the plurality of subpixel-shifted segmented images in the reference image;
calculating a third index in a first temporary overlap region where the target image and the reference image overlaps based on the first temporary region to obtain a first temporary value;
searching for a second temporary region having a fourth highest similarity between a second subpixel-shifted segmented image and the reference image in the reference image while scanning a sixth region having a same size as the second subpixel-shifted segmented image from among the plurality of subpixel-shifted segmented images;
calculating a second temporary index in a second overlap region where the target image and the reference image overlap based on the second temporary region to obtain a second temporary value; and
treating the first temporary value as the first value and treating the first subpixel-shifted segmented image as the first segmented image responsive to the first temporary value being less than or equal to the second temporary value.

6. The method of claim 5, wherein the generating the plurality of subpixel-shifted segmented images comprises:
shifting the first segmented image by a first predetermined size of subpixels in at least one of a first axis direction and a second axis direction.

7. The method of claim 5, wherein the generating the plurality of subpixel-shifted segmented images comprises:
shifting the first segmented image by a second predetermined size of subpixels in a first axis direction and a second axis direction.

8. The method of claim 5, wherein the generating the plurality of subpixel-shifted segmented images comprises:
shifting the first segmented image by a subpixel unit of a third predetermined size in a first axis direction and a second axis direction such that a sum of a first shifting distance in the first axis direction and a second shifting distance in the second axis direction is constant.

9. The method of claim 1, wherein the first index includes a ratio of a first area of the first overlap region and a second area of a threshold region in which a difference in pixel values between the target image and the reference image is greater than the binarization threshold value.

10. The method of claim 1, further comprising:
displaying the defect on a display device in an order of a calculated conversion area value among the detected defect according to an equation of:
$$converted area = area \times {( avg ( \vert ( \vert Δ graylevel ) ) )}^{n′}$$
wherein, converted area denotes a converted area value, area denotes an area of the defect after binarization, avg( ) is a first function to calculate an average, |(|) is a second function to calculate an absolute value, Δgraylevel is a difference in gray level between a target image and a reference image in each binarized region, and n denotes a real number.

11. A processor-implemented method, the method comprising:
segmenting a target image to obtain a plurality of segmented images;
searching for a first region having a first highest similarity between a first segmented image of the plurality of segmented images and a reference image while scanning a reference region having a same size as the first segmented image from among the plurality of segmented images in the reference image;
calculating a first index in a first overlap region where the target image and the reference image overlaps based on the first region to obtain a first value;
searching for a second region having a second highest similarity between a second segmented image of the plurality of segmented images and the reference image in the reference image while scanning a third region having a same size as the second segmented image form among the plurality of segmented images;
calculating a second index in a second overlap region where the target image and the reference image overlap based on the second region to obtain a second value;
determining a position at which the target image and the reference image are aligned as a final alignment position, such that a portion corresponding to the first segmented image in the target image corresponds to the first region in the reference image responsive to the first value being less than or equal to the second value; and
detecting a defect by applying a binarization threshold value to a difference in pixel values between the target image and the reference image in the final alignment position.

12. The method of claim 11, further comprising:
determining a plurality of subpixel-shifted segmented images by applying subpixel shift for the first segmented image;
searching for a first temporary region having a third highest similarity between a first subpixel-shifted segmented image and the reference image while scanning a fourth region having a same size as the first subpixel-shifted segmented image from among the plurality of subpixel-shifted segmented images in the reference image;
calculating a first temporary index in first temporary overlap region where the target image and the reference image overlaps based on the first temporary region to obtain a first temporary value;
searching for a second temporary region having a fourth highest similarity between a second subpixel-shifted segmented image and the reference image in the reference image while scanning a fifth region having a same size as the second subpixel-shifted segmented image from among the plurality of subpixel-shifted segmented images;
calculating a second temporary index in a second temporary region where the target image and the reference image overlap based on the second temporary region to obtain a second temporary value; and
treating the first temporary value as the first value and treating the first subpixel-shifted segmented image as the first segmented image responsive to the first temporary value being less than or equal to the second temporary value.

13. The method of claim 12, wherein the determining the plurality of subpixel-shifted segmented images comprises:
shifting the first segmented image by a first predetermined size of subpixels in at least one of a first axis direction and a second axis direction.

14. The method of claim 12, wherein the determining the plurality of subpixel-shifted segmented images comprises:
shifting the first segmented image by a second predetermined size of subpixels in a first axis direction and a second axis direction.

15. The method of claim 12, wherein the determining the plurality of subpixel-shifted segmented images comprises:
shifting the first segmented image by a subpixel unit of a third predetermined size in a first axis direction and a second axis direction such that a sum of a first shifting distance in the first axis direction and a second shifting distance in the second axis direction is constant.

16. An electronic apparatus comprising:
one or more processors comprising processing circuitry; and
a memory comprising one or more storage media storing instructions that, when executed individually or collectively by the one or more processors, cause the electronic apparatus to:
segment a target image to obtain a plurality of segmented images;
search for a first region having a first highest similarity between a first segmented image of the plurality of segmented images and a reference image while scanning a reference region having a same size as the first segmented image from among the plurality of segmented images in the reference image;
calculate a first index in a first overlap region where the target image and the reference image overlaps based on the first region to obtain a first value;
search for a second region having a second highest similarity between a second segmented image of the plurality of segmented images and the reference image in the reference image while scanning a third region having same size as the second segmented image from among the plurality of segmented images;
calculate a second index in a second overlap region where the target image and the reference image overlap based on the second region to obtain a second value;
determine a position at which the target image and the reference image are aligned as a final alignment position, such that a portion corresponding to the first segmented image in the target image corresponds to the first region in the reference image responsive to the first value being less than or equal to the second value; and
detect a defect by applying a binarization threshold value to a difference in pixel values between the target image and the reference image in the final alignment position.

17. The apparatus of claim 16, wherein the instructions further cause the electronic apparatus to:
determine a plurality of subpixel-shifted segmented images by applying a subpixel shift for the first segmented image;
search for a first temporary region having a third highest similarity between a first subpixel-shifted segmented image and the reference image while scanning a fourth region having a same size as the first subpixel-shifted segmented image from among the plurality of subpixel-shifted segmented images in the reference image;
calculate a first temporary index in a first temporary overlap region where the target image and the reference image overlaps based on the first temporary region to obtain a first temporary value;
search for a second temporary region having a fourth highest similarity between a second subpixel-shifted segmented image and the reference image in the reference image while scanning a fifth region having a same size as the second subpixel-shifted segmented image from among the plurality of subpixel-shifted segmented images;
calculate a second temporary index in a second temporary overlap region where the target image and the reference image overlap based on the second temporary region to obtain a second temporary value; and
treat the first temporary value as the first value and treat the first subpixel-shifted segmented image as the first segmented image responsive to the first temporary value being less than or equal to the second temporary value.

18. The apparatus of claim 17, wherein the determining the plurality of subpixel-shifted segmented images comprises:
shifting the first segmented image by a first predetermined size of subpixels in at least one of a first axis direction and a second axis direction.

19. The apparatus of claim 17, wherein the determining the plurality of subpixel-shifted segmented images comprises:
shifting the first segmented image by a second predetermined size of subpixels in a first axis direction and a second axis direction.

20. The apparatus of claim 17, wherein the determining the plurality of subpixel-shifted segmented images comprises:
shifting the first segmented image by a subpixel unit of a third predetermined size in a first axis direction and a second axis direction such that a sum of a first shifting distance in the first axis direction and a second shifting distance in the second axis direction is constant.
